(19) United States
(12) Patent Application Publication
(10) Pub. No.: US 2008/0210695 A1
(43) Pub. Date: Sep. 4, 2008

(54) Insulated folding trivet and method of use

(76) Inventors: Kevin Day, Old Tappan, NJ (US); Steve Booth, Nr. Newport (GB)

Correspondence Address: LATHROP & GAGE LC, 2345 GRAND AVENUE, SUITE 2800, KANSAS CITY, MO, 64108, US

(21) Appl. No.: 12/026,288

(22) Filed: Feb. 5, 2008

Related U.S. Application Data
(60) Provisional application No. 60/888,111, filed on Feb. 5, 2007.
(60) Provisional application No. 60/940,553, filed on May 29, 2007.

(51) Int. Cl. A47J 39/00; B65D 25/00

(52) U.S. Cl. 220/592.22; 220/739; 220/737

(57) ABSTRACT

An insulated folding trivet comprising a bottom panel and side panels made of decorative fabric stores flat and folds up to form a trivet for use with hot or cold serving dishes. The sides are foldably attached to the bottom and include releasable connectors to hold the sides in their upright position during use. The trivet may be designed to encase multiple serving dishes with a variety of shapes and sizes.

### RELATED APPLICATIONS

This application claims the benefit of U.S. Provisional Application No. 60/888,111 filed Feb. 5, 2007 and U.S. Provisional Application No. 60/940,553 filed May 29, 2007, the disclosures of which are herein incorporated by reference.

### BACKGROUND OF THE INVENTION

1. Field of the Invention

An insulated holder or trivet for serving or cooking dishes is described. In one embodiment, a trivet is described that lays flat for packing or storage, and folds up and fastens around a serving or cooking dish or food item when in use. In other embodiments, the trivet is permanently fastened with the sides folded up for use.

2. Prior Art

It is often desired to serve food in the dish in which it was prepared. Often these dishes are hot and remain so throughout serving of the food. The use of hot dishes to serve food may result in damage to the surface of serving tables, as well as discomfort to those handling the hot dishes with unprotected hands.

Pot or dish holders are well known in the art, and may be made from cloth, metal, ceramic or other material. Such holders may be flat for protecting only the surface of a table. They may also be raised or shaped to hold a dish, and formed from metal, wicker or some other rigid material. Such holders, or trivets, are typically complicated and relatively expensive to manufacture, bulky to ship and store, and are often limited to use with a specific dish. They may also be designed to insulate the sides of a serving dish. Examples of the field are described in the patents set forth below.

U.S. Pat. No. 5,598,946 to Davis for an Insulated Fabric Serving Dish Holder provides an insulated fabric holder with a bottom and perpendicular sides, but the sides do not fold down to reduce the bulk of the holder during shipment or storage.

U.S. Pat. No. 3,990,495 to LaBarba for an Insulated Warmer and Server Receptacle provides a fabric envelope capable of receiving insulating inserts for holding a serving dish. However, the envelope does not fold flat for storage, and the sides of the envelope are permanently attached to each other.

As noted above, such trivets are bulky and do not store conveniently or efficiently. The insulated folding trivet described in this application resolves this problem by providing a trivet that protects the sides of a serving dish while storing flat when not in use.

### SUMMARY OF THE INVENTION

The insulated folding trivet provides an insulated holder for hot or cold serving dishes. The insulated holder serves to maintain the food at a desired temperature during serving, and also protects the surface of tables and the hands of servers from discomfort or injury due to contact with the hot or cold serving dish. Further, the sides of the insulated trivet fold up to form an enclosure around the bottom and sides of a dish during use, and when not in use the trivet lays flat for ease of manufacture, packaging, shipping and storage in the kitchen.

### BRIEF DESCRIPTION OF THE DRAWINGS

FIG. 1 is a perspective view of an embodiment of the insulated folding trivet with sides folded up for use.

FIG. 2 is a top view of an embodiment of the insulated folding trivet with the sides laid flat.

FIG. 3 is a top view of an embodiment of the insulated folding trivet with a substantially square base, and the sides laid flat.

FIG. 4 is a perspective view of an embodiment of the insulated trivet with a substantially circular base and sides permanently fixed in the folded position.

FIG. 5 is a perspective view of an embodiment of the insulated trivet with a substantially oval base and sides permanently fixed in the folded position.

### DETAILED DESCRIPTION

The insulated folding trivet comprises multiple layers of materials. These layers include a bottom layer of fabric, a layer of insulating material, a top layer of fabric, and releaseable connectors. The bottom layer and top layer of fabric may be printed with decorative patterns or designed to match or complement a specific cooking or serving dishes, table clothes or other tableware. Either one or both of the layers of fabric may be quilted, and may preferably use ¼ inch to ½ inch batting.

The layer of insulating material may be formed from a variety of materials, preferably chip board of approximately 2 millimeters in thickness. In one embodiment of the invention, the fabric bottom layer and fabric top layer are sewn together, thus securing the insulating material between the top and bottom layers. The top and bottom layers of fabric may be sewn together along the edges of the trivet, and also across the trivet to facilitate folding of the trivet.

The releaseable connectors are attached approximately on the edge of the trivet, and may be of a variety of types known for releaseably connecting layers of fabric, preferable ties made from fabric, cord or lace, or multi-part snaps, hooks, buttons, magnetic clasps or other releaseable connectors. In the embodiment of the insulated folding trivet shown in the figures, the releaseable connectors comprise fabric ties sewn in between the top and bottom fabric layers.

The top and bottom layers of fabric in the folding trivet are sewn together along seams to create multiple panels in the trivet for the purpose of folding the trivet to create sides. In the embodiment shown in the figures, the trivet has a bottom panel, on which a serving dish may rest, and one or more side panels, which may be folded up and connected to adjacent side panels by means of the releaseable connectors attached to the edge of the trivet. When folded up and interconnected, the side panels provide protection for the sides of the serving dish. When the side panels are not interconnected they may be laid flat for ease of storage. The bottom panel may be a formed in a number of shapes, including bottom panels that are substantially circular, square, rectangular or oval.

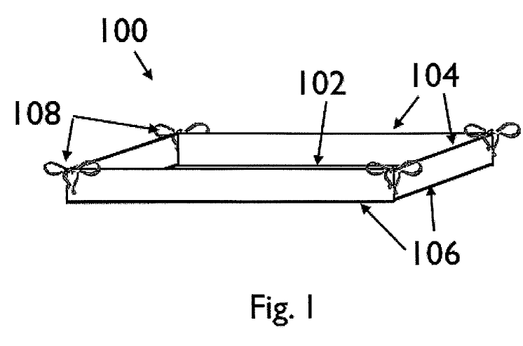

Referring to FIG. 1, a perspective view of an embodiment of the insulated folding trivet is shown with side panels folded up and fastened for use with a cooking or serving dish. The insulated folding trivet 100 has a bottom panel 102 and four folding side panels 104. The bottom panel 102 and the side panels 104 are foldably connected along fold lines 106. The side panels 104 are releaseably attached to adjacent side panels 104 at connection points near each corner of the trivet 100 by releaseable connectors 108. This embodiment of the trivet 100 is shown with fabric tie connectors 108 for releasably connecting side panels 104 to each other, however other releaseable connectors for use with fabric may also be used, including magnets, snaps, buttons, pins, zippers, drawstrings, or other such connectors.

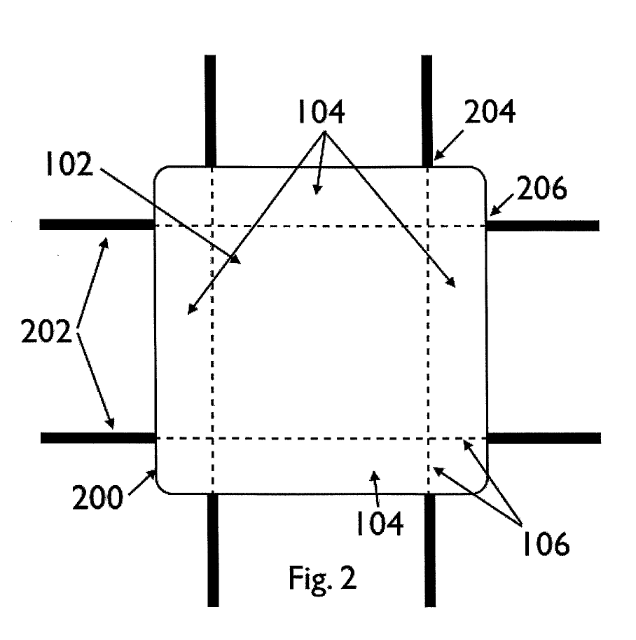

Referring to FIG. 2, a top view of an embodiment of the insulated folding trivet 100 is shown with the side panels laid flat. The trivet 100 comprises an insulating panel 200 and releaseable connectors 202 attached to the edge thereof. Insulating panel 200 is subdivided into a bottom panel 102 that is foldably connected to side panels 104 along fold lines 106. Bottom panel 102 and side panels 104 are comprised of multiple layers and contain internal layers of insulating material as described above. Bottom panel 102 and side panels 104 may preferably be formed from continuous pieces of fabric with stitches along fold lines 106 to maintain the internal insulating layers in the appropriate position. Alternatively, bottom panel 102 and side panels 104 may be formed individually and foldably joined at fold lines 106, by stitching, taping, gluing, stapling, or similar means.

Releaseable connectors 202 are permanently attached to insulating panel 200 at points 204 and 206. The connectors provide for the releaseable connection of two adjacent side panels 104 when the side panels are in the upright folded position and points 204 and 206 are immediately adjacent to one another. Similar releaseable connections are made at each corner of this embodiment of trivet 100.

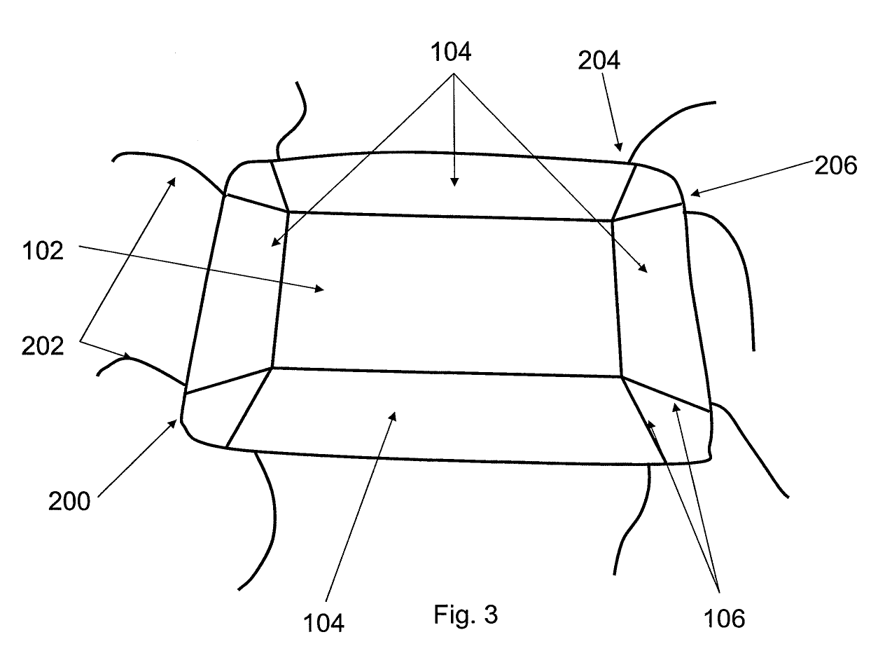

Referring to FIG. 3, a perspective view of trivet 100 with a square base is shown. The description of FIG. 2 applies equally to FIG. 3. FIG. 3 also shows the use of decorative fabric, contrasting stitching, and decorative edging to improve the appearance of the trivet 100. The trivet 100 of FIG. 3 also shows that fold lines 106 may be angled with respect to the edge of the trivet 100.

In the embodiment shown in FIG. 3, the fold lines 106 are at an acute angle with respect to the adjacent fold line 106. The angle 302 of separation between adjacent fold lines 106 alters the folded configuration of the trivet 100 by altering the angle at which adjacent side panels 104 meet.

For a trivet 100 with a square base, when the angle 302 is a right angle, the side panels 104 will meet when both panels are perpendicular to each other, and to the surface on which they are resting. When the angle 302 is an acute angle, side panels 104 will come together before reaching a perpendicular position. This creates a folded trivet 100 with side panels 104 that are slanted outward, in a shape similar to a bowl.

If the angle 302 of separation is an obtuse angle, then the side panels 104 will pass through the perpendicular before meeting, thus creating a folded configuration with the side panels 104 slanted inward.

If the base is of a shape other than square, the variation in the angle 302 between adjacent fold lines 104 will have a similar effect upon the slant of the side panels 104 when in the folded configuration.

In other embodiments of the insulated folding trivet, the trivet may be oval, rectangular, or otherwise shaped to fit other types of serving dishes. The shape of the embodiment described in the figures is not intended to limit the scope of the invention. Such embodiments may have more or fewer releaseable connectors, side panels, or layers of fabric than described in the embodiment shown in the figures.

In other embodiments of the insulated trivet the releaseable connectors may be replaced with permanent or fixed connections between the side panels of the trivet, securing the trivet in its folded position. The side panels may be fixed at one point or continuously along the adjacent edges of the side panels.

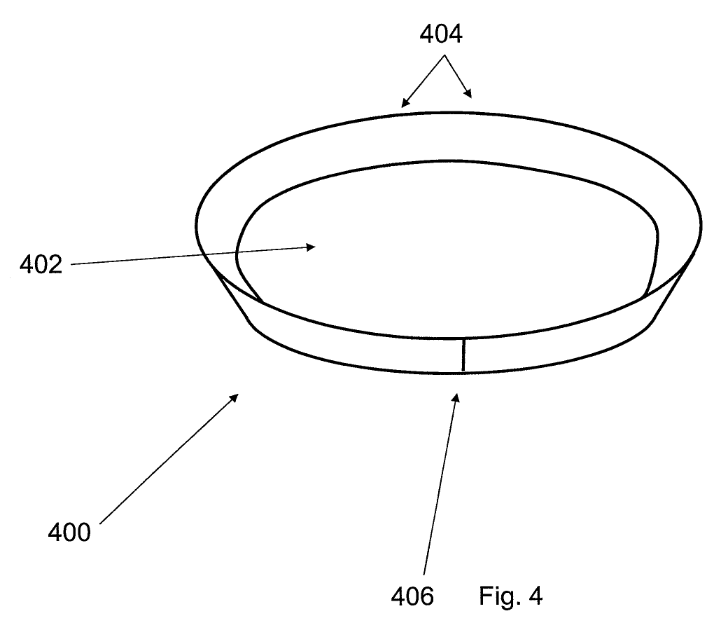

Referring to FIG. 4, an embodiment of the trivet, 400, with a substantially circular base 402 is shown. The trivet 400 has two side panels 404 which are permanently attached to each other along their adjacent edges, 406.

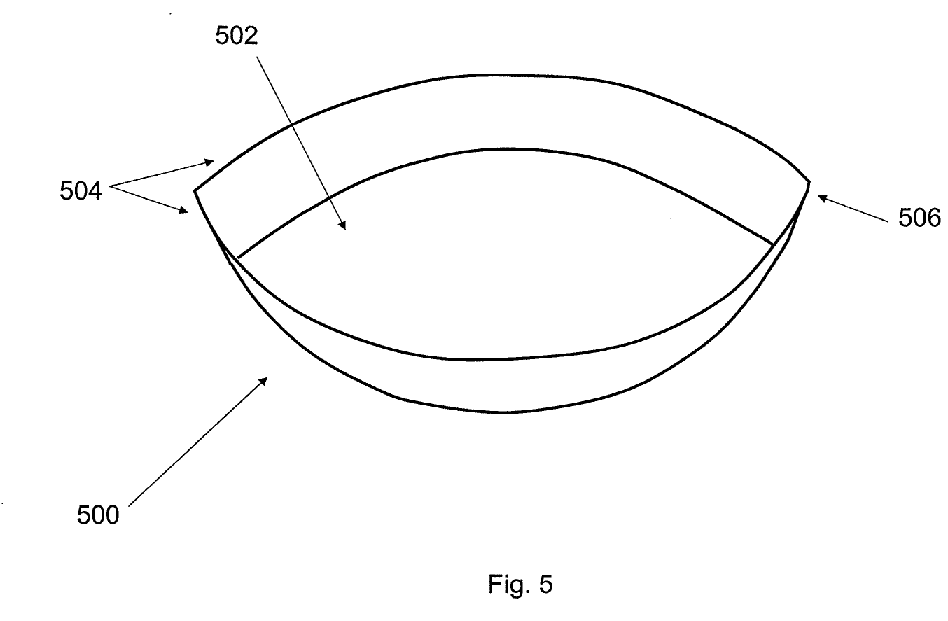

Referring to FIG. 5, an embodiment of the trivet, 500, with a substantially oval base 502 is shown. The trivet 500 has two side panels 504 which are permanently attached to each other along their adjacent edges 506.

In addition to use with a serving dish, the insulated folding trivet may be used to serve hot foods without an additional serving dish. For example, hot rolls or baked potatoes may be served directly from the trivet without any additional cookware.

What is claimed is:

1. An insulated folding trivet, comprising:
a bottom panel, comprising a bottom fabric layer, an insulating layer, and a top fabric layer;
a plurality of side panels, each side panel comprising a bottom fabric layer, an insulating layer and a top fabric layer;
a plurality of releaseable connectors attached to each side panel;
wherein the plurality of side panels are foldably connected to the bottom panel; and
wherein each of the side panels may be releaseably connected to another side panel by the releaseable connectors.

2. The insulated folding trivet of claim wherein the bottom panel is one of a circle, a square, a rectangle or an oval.

3. The insulated folding trivet of claim 1 wherein there are 1, 2, 3 or 4 side panels.

4. The insulated folding trivet of claim 1 wherein the releaseable connectors are snaps, buttons, hooks, magnetic clasps or fabric, cord or lace ties.

5. A method for using an insulated folding trivet, the method comprising:
providing a foldable trivet comprising:
a bottom panel;
a plurality of side panels;
a plurality of releaseable connectors;
wherein the side panels are foldably connected to the bottom panel; and
wherein the releaseable connectors are attached to the side panels;
providing a serving dish or a food item on the foldable trivet;
folding the side panels of the trivet; and
releaseably connecting the side panels to hold the side panels in a folded position.
